(19) United States
(12) Patent Application Publication
(10) Pub. No.: US 2024/0362894 A1
(43) Pub. Date: Oct. 31, 2024

(54) APPARATUS AND METHOD WITH IMAGE PROCESSING

(71) Applicant: SAMSUNG ELECTRONICS CO., LTD., Suwon-si (KR)

(72) Inventors: Xiaoxuan YU, Beijing (CN); Weiming LI, Beijing (CN); Hao WANG, Beijing (CN); Jingrui SONG, Beijing (CN); Qiang WANG, Beijing (CN); SoonYong CHO, Suwon-si (KR); Young Hun SUNG, Suwon-si (KR)

(73) Assignee: SAMSUNG ELECTRONICS CO., LTD., Suwon-si (KR)

(21) Appl. No.: 18/647,301

(22) Filed: Apr. 26, 2024

(30) Foreign Application Priority Data
Apr. 28, 2023 (CN) 202310487822.6
Apr. 3, 2024 (KR) 10-2024-0045108

(51) Int. Cl. G06V 10/77; G06T 17/00; G06V 10/46; G06V 10/82; G06V 20/70

(52) U.S. Cl. CPC G06V 10/7715; G06T 17/00; G06V 10/46; G06V 10/82; G06V 20/70; G06T 2210/56

(57) ABSTRACT

A processor-implemented method with image processing includes obtaining point cloud data of a target scene, generating a feature map of the point cloud data by extracting a feature from the point cloud data, for each of a plurality of objects included in the target scene, generating a feature vector indicating the object in the target scene based on the feature map, and reconstructing a panorama of the target scene based on the feature vectors of the objects.

### CROSS-REFERENCE TO RELATED APPLICATIONS

This application claims the benefit under 35 USC § 119 (a) of Chinese Patent Application No. 202310487822.6 filed on Apr. 28, 2023, in the China National Intellectual Property Administration, and Korean Patent Application No. 10-2024-0031355 filed on Mar. 5, 2024, in the Korean Intellectual Property Office, the entire disclosures of which are incorporated herein by reference for all purposes.

### BACKGROUND

### 1. Field

The following description relates to an apparatus and method with image processing.

### 2. Description of Related Art

Augmented reality (AR) may provide a user with a realistic information experience by adding virtual content to a real scene in front of the user's eyes. High-precision real-time processing and understanding of three-dimensional (3D) states of surrounding objects may be used for an AR system to complete high-quality virtual and real fusion effects in a 3D space. However, an effect provided by a typical AR technique to the user does not meet the user's expectations.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method with image processing includes obtaining point cloud data of a target scene, generating a feature map of the point cloud data by extracting a feature from the point cloud data, for each of a plurality of objects included in the target scene, generating a feature vector indicating the object in the target scene based on the feature map, and reconstructing a panorama of the target scene based on the feature vectors of the objects.

For each of the objects, the feature vector of the object may include a semantic feature related to semantics of the object and a geometric feature related to geometry of the object.

For each of the objects, the generating of the feature vector of the object indicating the object included in the target scene based on the feature map may include obtaining an initial feature vector of the object, and obtaining the feature vector of the object by processing the feature map and the initial feature vector of the object by using a neural network, wherein the initial feature vector may include an initial semantic feature related to semantics of the object and an initial geometric feature related to geometry of the object.

The neural network may be a transformer network comprising one or more sub-neural networks comprising any one or any combination of any two or more of a cross attention layer, a self-attention layer, and a feed forward neural network layer.

The reconstructing of the panorama of the target scene based on the feature vectors of the objects may include, for each of the objects, obtaining a semantic label of the object, a mask of the object, a shape-related latent variable of the object, and pose information of the object by inputting the feature vector of the object to one or more neural networks, respectively, and reconstructing the panorama of the target scene based on the semantic label of the object, the shape-related latent variable of the object, and the pose information of the object, wherein the semantic label of the object is obtained based on the semantic feature of the feature vector.

The reconstructing of the panorama of the target scene may include obtaining subdivided pose information of the object as pose information of the object based on the mask of the object, the pose information of the object, and the pose cloud data, obtaining a subdivided shape-related latent variable of the object as a shape-related latent variable of the object based on the mask of the object, the shape-related latent variable of the object, and the point cloud data, and reconstructing the panorama of the target scene based on the semantic label of the object, the mask of the object, and the shape-related latent variable of the object, and the pose information of the object.

The obtaining of the subdivided pose information of the object may include obtaining a pose-related feature of the object by processing the mask of the object, the pose information of the object, and the point cloud data, obtaining pose-related residual information of the object based on the pose-related feature of the object and the feature vector of the object, and obtaining subdivided pose information of the object based on the pose-related residual information of the object and the pose information of the object.

The obtaining of the subdivided shape-related latent variable may include obtaining the shape-related feature of the object by processing the mask of the object, the shape-related latent variable of the object, and the point cloud data, obtaining shape-related residual information of the object based on the shape-related feature of the object and the feature vector of the object, and obtaining the subdivided shape-related latent variable of the object based on the shape-related residual information of the object and the shape-related latent variable of the object.

The method may include determining whether the target scene is a new scene, in response to determining that the target scene a new scene, storing the feature vector of the object, and, in response to determining that the target scene is a scene associated with a previous scene, obtaining an initial feature vector of an object corresponding to the target scene by initializing a feature vector of the object corresponding to the target scene by using a feature vector of an object included in the previous scene.

The determining of whether the target scene is a new scene may include outputting information that asks whether the target scene is a new scene, in response to feedback information being received, determining whether the target scene is a new scene based on the feedback information, and, in response to the feedback information not being received, determining the target scene to be the new scene.

The reconstructing of the panorama of the target scene may include obtaining an object grid of the object by decoding the latent variable using a decoder, and obtaining a panoramic view of the target scene by combining the semantic label of the object, the mask of the object, the object grid of the object, and the pose information of the object.

In one or more general aspects, a non-transitory computer-readable storage medium may store instructions that, when executed by one or more processors, configure the one or more processors to perform any one, any combination, or all of operations and/or methods disclosed herein.

In one or more general aspects, an electronic device includes one or more processors configured to obtain point cloud data of a target scene, generate a feature map of the point cloud data by extracting a feature from the point cloud data, for each of a plurality of objects included in the target scene, generate a feature vector indicating the object in the target scene based on the feature map, and reconstruct a panorama of the target scene based on the feature vectors of the objects.

For the generating of the feature vector of the object for each of the objects, the one or more processors may be configured to obtain an initial feature vector of the object, and obtain the feature vector of the object by processing the feature map and the initial feature vector of the object by using a neural network, wherein the initial feature vector may include an initial semantic feature related to semantics of the object and an initial geometric feature related to geometry of the object.

For the reconstructing of the panorama of the target scene, the one or more processors may be configured to, for each of the objects, obtain a semantic label of the object, a mask of the object, a shape-related latent variable of the object, and pose information of the object by inputting the feature vector of the object to one or more neural networks, respectively, and reconstruct the panorama of the target scene based on the semantic label of the object, the shape-related latent variable of the object, and the pose information of the object.

For the reconstructing of the panorama of the target scene, the one or more processors may be configured to obtain subdivided pose information of the object as pose information of the object based on the mask of the object, the pose information of the object, and the pose cloud data, obtain a subdivided shape-related latent variable of the object as a shape-related latent variable of the object based on the mask of the object, the shape-related latent variable of the object, and the point cloud data, and reconstruct the panorama of the target scene based on the semantic label of the object, the mask of the object, and the shape-related latent variable of the object, and the pose information of the object.

For the obtaining of the subdivided pose information, the one or more processors may be configured to obtain a pose-related feature of the object by processing the mask of the object, the pose information of the object, and the point cloud data, obtain pose-related residual information of the object based on the pose-related feature of the object and the feature vector of the object, and obtain subdivided pose information of the object based on the pose-related residual information of the object and the pose information of the object.

For the obtaining of the subdivided shape-related latent variable, the one or more processors may be configured to obtain the shape-related feature of the object by processing the mask of the object, the shape-related latent variable of the object, and the point cloud data, obtain shape-related residual information of the object based on the shape-related feature of the object and the feature vector of the object, and obtain the subdivided shape-related latent variable of the object based on the shape-related residual information of the object and the shape-related latent variable of the object.

The one or more processors may be configured to determine whether the target scene is a new scene, in response to determining that the target scene is a new scene, store the feature vector of the object, and, in response to determining that the target scene is a scene associated with a previous scene, obtain an initial feature vector of an object corresponding to the target scene by initializing a feature vector of the object corresponding to the target scene by using a feature vector of an object included in the previous scene.

For the reconstructing of the panorama of the target scene, the one or more processors may be configured to obtain an object grid of the object by decoding the latent variable using a decoder, and obtain a panoramic view of the target scene by combining the semantic label of the object, the mask of the object, the object grid of the object, and the pose information of the object.

Other features and aspects will be apparent from the following detailed description, the drawings, and the claims.

### BRIEF DESCRIPTION OF THE DRAWINGS

FIG. 1 is a flowchart of an image processing method according to one or more embodiments of the present disclosure.

FIG. 2 is an architecture diagram of an image processing model according to one or more embodiments of the present disclosure.

FIG. 3 is an example of a slot attention competition mechanism according to one or more embodiments of the present disclosure.

FIG. 4 is an example of a slot attention model according to one or more embodiments of the present disclosure.

FIG. 5 is an example of a slot attention model according to one or more embodiments of the present disclosure.

FIG. 6 is an example of panorama reconstruction using a decoupled slot according to one or more embodiments of the present disclosure.

FIG. 7 is an example of applying an image processing model to an augmented reality (AR) device according to one or more embodiments of the present disclosure.

FIG. 8 is an example of first neural network training according to one or more embodiments of the present disclosure.

FIG. 9 is a flowchart of an image processing method according to one or more embodiments of the present disclosure.

FIG. 10 is an example of a flow of an image processing method according to one or more embodiments of the present disclosure.

FIG. 11 is an architecture diagram of an image processing model according to one or more embodiments of the present disclosure.

FIG. 12 is a flowchart of an image processing method according to one or more embodiments of the present disclosure.

FIG. 13 is an example of subdivided pose information according to one or more embodiments of the present disclosure.

FIG. 14 is an example of a structure of an image processing apparatus in a hardware operating environment according to one or more embodiments of the present disclosure.

FIG. 15 is a block diagram of an electronic device according to one or more embodiments of the present disclosure.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The terminology used herein is for describing various examples only and is not to be limiting of the disclosure. The articles “a”, “an”, and “the” are intended to include the plural forms as well, unless the context clearly indicates otherwise. As non-limiting examples, terms “comprise” or “comprises,” “include” or “includes,” and “have” or “has” specify the presence of stated features, numbers, members, integers, steps, operations, elements, and/or components, but do not preclude the presence or addition of one or more other numbers, members, features, integers, steps, operations, elements, components and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms including technical and scientific terms used herein have the same meaning as commonly understood by one of ordinary skill in the art to which this disclosure pertains and based on an understanding of the disclosure of the present application. It will be further understood that terms, such as those defined in commonly-used dictionaries, should be interpreted as having a meaning that is consistent with their meaning in the context of the relevant art and the disclosure of the present application, and will not be interpreted in an idealized or overly formal sense unless expressly so defined herein.

When describing the embodiments with reference to the accompanying drawings, like reference numerals refer to like constituent elements and a repeated description related thereto will be omitted. In the description of embodiments, detailed description of well-known related structures or functions will be omitted when it is deemed that such description will cause ambiguous interpretation of the present disclosure.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

The same name may be used to describe an element included in the embodiments described above and an element having a common function. Unless otherwise mentioned, the descriptions on the embodiments may be applicable to the following embodiments and thus, duplicated descriptions will be omitted for conciseness.

In a typical method related to panorama reconstruction, a separated instance grid reconstruction framework is proposed for efficient point cloud scene understanding. The typical method related to panorama reconstruction may reduce prediction of a false positive object using a segmentation-based backbone network. Specifically, ambiguity due to an incomplete point cloud may be removed by separating shape supplementation from a grid generation process by utilizing a grid-aware latent variable space based on an accurate proposal. In addition, when accessing a computer aided design (CAD) model library during a test, CAD model may be used to improve reconstruction quality by performing a grid search without additional training. However, the typical method may obtain only a semantic reconstruction result related to a specific object in a scene and may not obtain a reconstruction result related to a room structure, such as a wall or a floor. The reconstruction result generated by the typical method may be insufficient to support a use in an actual augmented reality (AR) application. Additionally, such an accessing manner does not limit a similarity between latent code of a grid-aware shape and an original input point cloud, whereas there is no input consistency loss, and thus, there may be a significant difference between a reconstructed grid generated by the typical method and an original point cloud.

In addition, an end-to-end accessing method of searching for a 3D CAD model in a shape database and aligning to a single input image may be light and compact and may recognize an observed scene in a 2D RGB observation represented in CAD representation in 3D. A core of the method may be fine alignment optimization based on 2D-3D high-density object correspondence. Accordingly, the method may learn and search for a CAD model having a geometric similarity using a 2D-3D correspondence relationship while providing strong CAD alignment. A network for point scene understanding based on semantic instance reconstruction that jointly and directly detects and reconstructs a dense object surface in an original point cloud may use sparsity of the point cloud data and may focus on predicting a highly objective shape instead of representing a scene in a typical grid. Through this design, instance reconstruction may be divided into global object localization and local shape prediction. This may mitigate a difficulty in learning a 2D manifold surface in a sparse 3D space and a point cloud of each object proposal may transmit shape details information that supports implicit function training for reconstructing a high-resolution surface.

The typical method may be a two-step method (e.g., segmentation first or reconstruction after detection) and post-processing (e.g., non-maximum suppression of an instance subdivision result) may be required. When training a neural network in the typical two-step method, adjusting a hyperparameter may be significantly cumbersome, simultaneous optimization in each step may be difficult to be achieved, and the typical method may require additional post-processing.

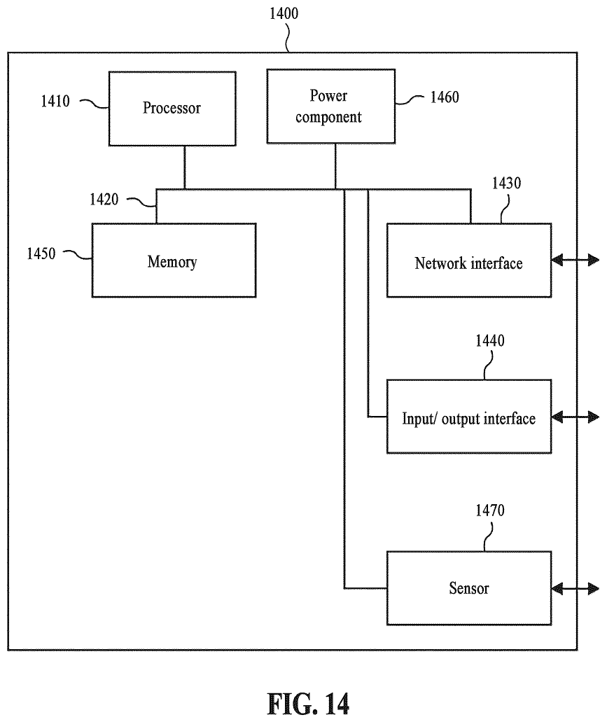

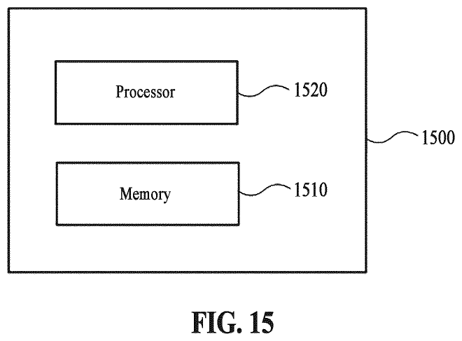

To solve the the technical problems of the typical methods described above, the present disclosure may propose a panorama reconstruction system and method of an object-centric indoor scene. The system and method of one or more embodiments may be implemented as a one-step model for scene panorama reconstruction by using an object-centric representation vector and may simultaneously perform panorama segmentation, object reconstruction, and pose estimation tasks. In addition, the model of one or more embodiments may be applied to an AR device (e.g., an image processing apparatus 1400 of FIG. 14 and/or an electronic device 1500 of FIG. 15) to improve a virtual-real interaction effect in an AR application.

Hereinafter, detailed descriptions of the method and device of the present disclosure are provided with reference to the accompanying drawings according to various embodiments of the present disclosure.

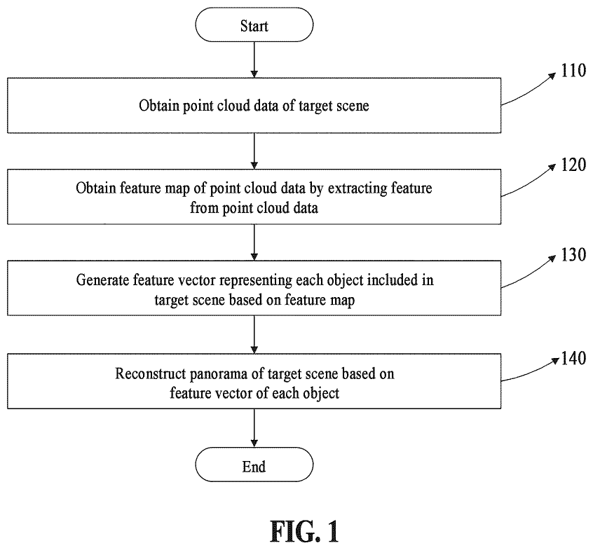

FIG. 1 is a flowchart of an image processing method according to one or more embodiments of the present disclosure.

The image processing method of the present disclosure may be performed by an electronic device (e.g., the image processing apparatus 1400 of FIG. 14 and/or the electronic device 1500 of FIG. 15) equipped with an image processing function. The electronic device may be, for example, a smartphone, a tablet computer, a portable computer, and/or a desktop computer.

In operation 110, the image processing method of the present disclosure may obtain point cloud data of a target scene. The point cloud data may be a set of points in a 3D space and may be collected through techniques, such as 3D scanning, a high-resolution camera, and/or lidar (LiDAR). In this case, each point in the 3D space may have X, Y, Z coordinates and sometimes, may include additional information (e.g., a color, intensity of light, and/or a physical characteristic). For example, point cloud data of a specific scene may be obtained by scanning each object in the specific scene using a 3D scanning apparatus (e.g., LiDAR (2D or 3D), RGB binoculars, a 3D structure light camera, and/or a time-of-flight camera), measuring information on multiple points of the surface of each object, and then outputting the point cloud data using a specific data file. Each point of the point cloud data may include rich information, such as 3D coordinates X, Y, Z, a color, a classification value, an intensity value, and/or time. A real world may be reconstructed through high-precision point cloud data. For example, when scanning an indoor scene, an object, such as a table, a chair, and a cup, in the indoor scene as well as a room structure, such as a wall and a floor, may be collected.

In operation 120, the image processing method of the present disclosure may obtain a feature map of the point cloud data by extracting a feature related to the point cloud data. The image processing method may extract the feature map of the point cloud data by using a neural network that processes 3D point cloud data. For example, the image processing method may obtain the feature map of the point cloud data by extracting a feature from the point cloud data by using sparse 3D U-NET and/or a dynamic graph convolutional neural network (DGCNN). The example described above is only an example and the present disclosure is not limited thereto.

In operation 130, the image processing method of the present disclosure may generate a feature vector representing each object included in the target scene based on the feature map of the point cloud data. In the present disclosure, the feature vector of an object may be object-centric representation, and for example, may be a feature vector for representing the object. For example, the feature vector of the object may be an object-centric slot vector based on a slot. In addition, another object-centric representation may be used and the present disclosure is not limited thereto. The image processing method may perform object-centric feature vector representation on all objects included in the target scene through operation 130.

As an example of representing an object using a slot vector, the image processing method may obtain a slot vector of each object from an input feature map using a slot attention network (e.g., a network that maps N input feature vector sets to K output feature vectors called as a slot, wherein N may be determined based on a spatial dimension of an extracted feature and K may be determined based on the number of instances of a training data scene). For example, the representation of each slot may correspond to an object. For example, the slot attention network may apply an attention mechanism of slot attention to an input feature and may determine a degree of relevance between the input feature and the slot through the attention mechanism. Each slot may obtain an input feature associated with itself and each input feature may belong to at most one slot. A process of determining the degree of relevance between an input feature and a slot may be iteratively performed T times and the slot may correspond more to only one object through each iteration.

Since a typical slot attention network may be designed for image processing, the typical slot attention network may not be directly applied to point cloud processing and a scene panorama reconstruction task. By considering that point cloud processing and a scene panorama reconstruction task is different from image processing, when processing the point cloud data, the image processing method of one or more embodiments of the present disclosure may firstly convert an object point cloud into an object pose and may perform additional processing in response to normalizing the object point cloud to the object pose. Accordingly, the present disclosure may propose a decoupled feature vector including a first feature related to a shape of an object and a second feature related to a pose of the object. Taking a slot as an example, a feature of a first half of the slot may be a first feature related to a pose and a feature of a second half of the slot may be a second feature related to a shape, and the slot generated by the image processing method of one or more embodiments may be helpful in generating a more detailed reconstruction grid that is more suitable to panorama reconstruction of a scene compared to a typical slot.

According to one or more embodiments of the present disclosure, a feature vector of each object may be a decoupled slot vector. In this case, a portion of the decoupled slot vector may include a feature related to a shape of the object. The other portion of the decoupled slot vector may include a feature related to a pose of the object. The decoupled feature may be an example and may be decoupled in a different feature space, such as a color feature space, depending on a task.

When the feature vector representing the object is the decoupled feature vector, the image processing method may obtain an initial feature vector of each object in the target scene. In this case, the initial feature vector may include a first initial feature related to the shape of the object and a second initial feature related to the pose of the object. For example, the image processing method may obtain the feature vector of each object by processing the feature map of the point cloud data of the target scene and the initial feature vector of each object by using the attention network.

For example, when the feature vector of the object is a decoupled slot vector, the image processing method may obtain an initial slot vector of each object, may initialize a portion of the initial slot vector to represent a shape of a corresponding object, may initialize the other portion of the initial slot vector to represent a pose of the corresponding object, and may obtain a decoupled slot vector of each object by processing the feature map of the point cloud data and the initial slot vector by using the attention network.

According to one or more embodiments of the present disclosure, the image processing method may obtain a decoupled feature vector of each object by processing the feature map and the initial feature vector of each object by using a first attention network in the attention network and may obtain a feature vector of each object by applying a self-attention mechanism to the decoupled feature vector of each object by using a second attention network in the attention network.

For example, the first attention network may be a neural network to which an attention mechanism is applied and the second attention network may be a neural network to which a self-attention mechanism is applied. For example, the image processing method may obtain a first decoupled slot vector of each object by processing the feature map and the initial slot vector using the first attention network and may obtain a finally decoupled slot vector of each object by applying the self-attention mechanism to the first decoupled slot vector of each object by using the second attention network.

In operation 140, the image processing method of the present disclosure may perform panorama reconstruction of the target scene based on the feature vector of each object.

For example, the generated feature vector may be input to a first neural network for object shape reconstruction, a second neural network for object pose estimation, and a third neural network for panorama segmentation, and panorama reconstruction of the target scene may be performed based on an output of the first neural network, an output of the second neural network, and an output of the third neural network.

For example, the image processing method may obtain a latent variable related to the shape of each object by processing a first feature related to the shape in the feature vector of each object by using the first neural network, may obtain pose information of each object by processing a second feature related to the pose in the feature vector of each object by using the second neural network, and may obtain a semantic label and mask of each object with respect to the first feature and the second feature by using the third neural network. The first neural network, the second neural network, and the third neural network of one or more embodiments may be executed in parallel and may avoid training complexity and efficiency of a typical two-step (e.g., reconstruction after segmentation and/or detection) model and may enhance a panorama reconstruction effect.

For example, the image processing method may obtain an object grid of each object by decoding a latent variable related to the shape of each object by using a decoder (e.g., a decoder implemented as a neural network) and may obtain a panoramic view of the target scene by combining the semantic label and mask for each object, the object grid, and the object grid.

According to one or more embodiments of the present disclosure, a pose estimation result may be more accurately generated by subdividing pose information of the obtained object.

For example, the image processing method may obtain subdivided pose information based on the mask and pose information of the obtained each object and the point cloud data, and may perform panorama reconstruction of the target scene based on the obtained semantic label, mask, the latent variable related to the shape, and the subdivided pose information.

When subdividing the pose information, the image processing method may obtain a feature related to a pose by processing a mask of each obtained object, the pose information, and the point cloud data, may obtain residual information related to a pose of each object based on the feature related to the pose and a feature vector of each object, and may obtain subdivided pose information based on the residual information related to the pose and the pose information of each object. In response to obtaining the subdivided pose information, the image processing method may obtain a panoramic view of the target scene by combining the semantic label and mask of each object, the object grid, and the subdivided pose information. For example, the image processing method may obtain the feature related to the pose by passing coordinates of the object through a single multi-layer perceptron (MLP) by using an object mask and pose information predicted by the second neural network and the third neural network, may predict residual information of an object pose by combining the feature with a feature vector of the object, and may derive a final pose estimation result by aggregating the predicted pose information and the residual information.

According to one or more embodiments of the present disclosure, the image processing method may more accurately create a shape estimation result by further subdividing a latent variable related to the shape of the obtained object.

When segmenting a shape-related latent variable, the image processing method of the present disclosure may obtain a shape-related feature by processing a mask of each obtained object, a shape-related latent variable, and the point cloud data, may obtain residual information related to the shape of each object based on the shape-related feature and the feature vector of each object, and may obtain a subdivided shape-related latent variable based on the residual information related to the shape and the shape-related latent variable of each object.

For example, the image processing method may pass coordinates of the object through the MLP by using the predicted object mask and the shape-related latent variable, may predict residual information of the object shape by combining the feature with a feature vector of the object, and may derive a final shape estimation result by aggregating the residual information and the predicted shape-related latent variable.

When subdividing a prediction result, the image processing method may simultaneously subdivide a plurality of prediction results (e.g., a shape-related latent variable, a mask, and pose information) or may individually subdivide specific or some prediction results (e.g., a shape-related latent variable, a mask, and pose information). However, the present disclosure does not limit the example.

According to one or more embodiments of the present disclosure, the feature vector of an object included in the target scene may be differently initialized depending on whether the target scene is a new scene. The image processing method may output information for querying whether the target scene is a new scene (e.g., the information may be displayed to a user and/or a voice including the information may be transmitted to a user), and when receiving feedback information about the information, the image processing method may determine whether the target scene is a new scene based on the feedback information. When the feedback information is not received (e.g., when the feedback information is not received within a predetermined time from the outputting of the information for querying whether the target scene is the new scene), the image processing method may determine that the target scene is a new scene. For example, in the case of a scanned scene point cloud, the image processing method may ask the user whether a current scene is a new scene or is an update for a previous scene. When the user does not provide a valid answer or provides an answer that the current scene is a new scene, the image processing method may determine the target scene to be a new scene. When the user responds that the current scene is an update for the previous scene, the image processing method may determine that the target scene is a scene associated with the previous scene (e.g., an updated scene of the previous scene).

When the target scene is a new scene, the image processing method may store the feature vector of each object and when the target scene is a scene associated with the previous scene, the image processing method may generate an initial feature vector of an object corresponding to the target scene by initializing the feature vector of the object corresponding to the target scene by using the feature vector of the object included in the previous scene. For example, the image processing method may find the same object included in the current scene from each object of the previous scene and may use a slot vector of a found object as an initial slot vector of the object corresponding to the current scene. In the case of a new object appearing in the current scene, the image processing method may arbitrarily initialize a feature vector of the new object. The image processing method of one or more embodiments of the present disclosure may provide accurate initialization for a panorama reconstruction process for a later scene by using the rapid slot search described above, and the user may update the entire scene with a small number of scans in a changed area.

According to one or more embodiments of the present disclosure, the image processing method of the present disclosure may consider an input consistency loss when training the first neural network to improve the consistency between a reconstructed grid and an input point cloud. For example, the image processing method may firstly obtain a training sample. In this case, the training sample may include point cloud data of a specific scene. For example, the point cloud data included in the training sample may be obtained by scanning a specific object (e.g., a specific object or a plurality of objects) of the specific scene. The image processing method may obtain a feature vector of the specific object of the specific scene based on the point cloud data of the specific scene. The image processing method may obtain a feature map of the point cloud data by extracting a feature from the point cloud data in a similar method described above and applying an attention mechanism to the feature. The image processing method may obtain a first latent variable related to a shape of the specific object by processing the feature vector of the specific object by using a specific neural network. The image processing method may configure a loss function based on the first latent variable, a second latent variable that is obtained based on input point cloud data corresponding to the specific object, and a third latent variable that is obtained based on an object grid corresponding to the specific object, and may obtain a first neural network by training the neural network by minimizing a loss determined by the loss function. In this case, the second latent variable may be obtained by processing the input point cloud data of the specific object through an encoder and the third latent variable may be obtained by processing an object network of the specific object through the encoder. The second latent variable and the third latent variable may be obtained by using the same or different encoders.

A system and method of object-centric panorama reconstruction of an indoor scene of one or more embodiments of the present disclosure may enable identification, segmentation, 3D pose estimation, and panorama reconstruction of all objects in a scene to improve an effect of real-virtual interaction in an AR application.

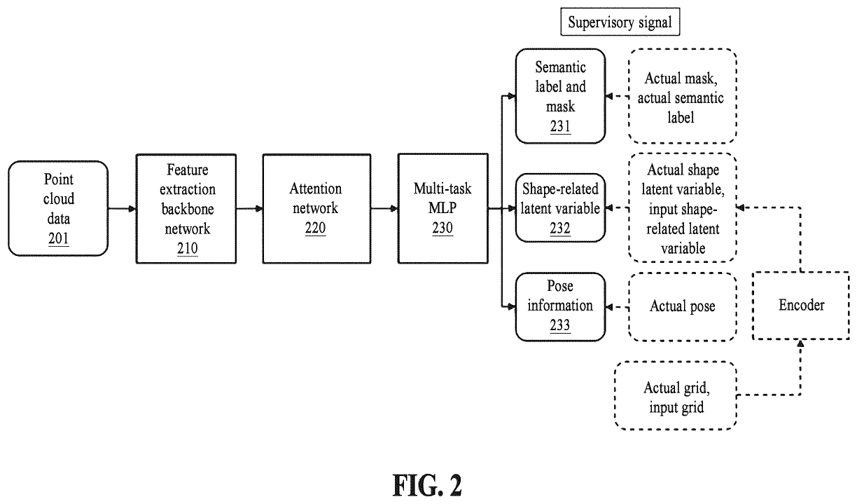

FIG. 2 is an architecture diagram of an image processing model according to one or more embodiments of the present disclosure.

The image processing model shown in FIG. 2 may include a feature extraction backbone network 210, an attention network 220, and a multi-task MLP 230.

Referring to FIG. 2, when the feature extraction backbone network 210 receives point cloud data 201, the feature extraction backbone network 210 may extract a feature from the point cloud data 201. In this case, the feature extraction backbone network 210 may extract a feature from the point cloud data by using sparse 3D U-NET and/or DGCNN.

In this case, the point cloud data 201 may be point cloud data of each object obtained by measuring a target scene using a 3D scanning device. Typically, the collected point cloud data 201 may be incomplete point cloud data because an occlusion situation may occur when measuring an object in a scene.

The attention network 220 may generate an object-centric feature vector for the extracted feature by the feature extraction backbone network 210. When the attention network 220 is a slot attention network, in attention iteration of each slot, each slot may compete for all features of a specific part (one object or entity) of a feature (a feature map) input through a softmax-based attention mechanism. Each slot may encode one object or one entity in the input point cloud. In the same manner described above, a slot vector for each object may be obtained.

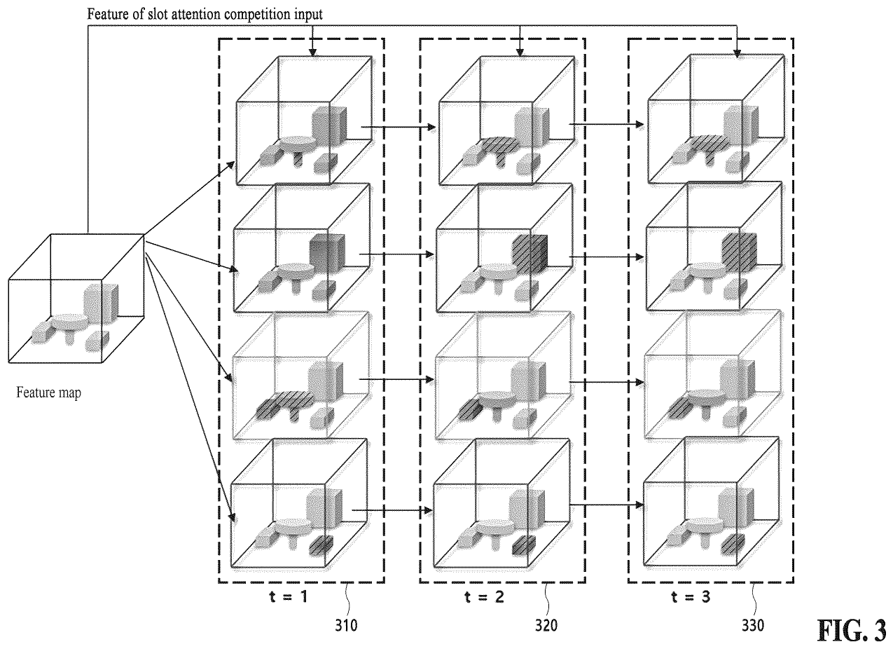

FIG. 3 is an example of a slot attention competition mechanism according to one or more embodiments of the present disclosure.

As shown in FIG. 3, in an indoor scene, an image processing method may obtain a slot vector representing each object (e.g., a table, a cabinet, and/or a stool) by applying an attention competition mechanism to a slot of a feature map of the scene.

In response to obtaining the slot vector of each object, the image processing method may input the slot vector to a multi-task MLP. For example, the multi-task MLP may include a plurality of MLPs, such as a first MLP 310 for performing a panorama segmentation task, a second MLP 320 for performing shape reconstruction of an object, and a third MLP 330 for performing pose estimation. The first MLP 310 may obtain a semantic label and mask of each object by processing an input slot vector, the second MLP 320 may obtain a latent variable related to a shape of each object (e.g., a shape-related latent variable) by processing the input slot vector, and the third MLP 330 may obtain pose information of each object by processing the input slot vector.

Each network shown in FIG. 2 is an example and the present disclosure may use another network to perform the task.

When training the network, the mask may use a binary cross entropy loss, the semantic label may use a cross entropy loss, the shape-related latent variable may use a weighted L1 loss, and the pose estimation result may use a combination of a cross entropy loss and a weighted L1 loss. For example, a binary cross entropy loss function may be configured by using an actual mask and a predicted mask, and a cross entropy loss function may be configured by using an actual semantic label and a predicted semantic label. The image processing model of the present disclosure may configure a weighted L1 loss function by using a latent variable related to an actual shape (e.g., obtained by processing an actual network through a neural network-based encoder), a latent variable related to an input shape (e.g., obtained by processing an object point cloud input through a neural network-based encoder), and a latent variable related to a predicted shape, and may configure a hybrid loss function based on a cross entropy loss and a weighted L1 loss by using an actual pose and a predicted pose. The image processing model of the present disclosure may train or update a network parameter of the image processing model by minimizing a result of the configured loss function. The loss is an example and the present disclosure is not limited thereto.

For example, when training the image processing model of the present disclosure, the model may be trained based on a mask-related loss Lmask, a semantic-related loss Lsem, a shape-related loss Lshape, and a pose-related loss Lbbox. Among them, the mask-related loss Lmask may be determined based on the binary cross entropy loss and a Dice loss, the pose-related loss Lbbox may be determined by a loss related to a pose center, a loss related to a pose range, and a loss related to a pose angle. The example described above is an example and the present disclosure is not limited thereto.

The image processing model shown in FIG. 2 may be an integrated single-step model to apply the model to an AR device by using slot-based object-centric representation and technique to simultaneously perform object shape reconstruction and pose estimation. The image processing model may simultaneously generate a semantic label and mask 231 for segmenting each object displayed as a slot, pose information 233 (e.g., a position and a direction), and a shape-related latent variable 232, which is a latent variable indicating the shape, through a shape dictionary at an object category level that the network learned. The image processing model may reduce complexity of hyperparameter adjustment and may prevent additional post-processing. Simultaneously, a result output by the image processing model may be used for an actual AR application.

The image processing model of the present disclosure may obtain the semantic label and mask 231 of each object, the shape-related latent variable 232, which is a variable, and the pose information 233, may obtain an object grid by reconstructing the shape-related latent variable 232 through decoding, and then may generate panorama reconstruction of a final scene by performing a direct combination task on a panorama mask, a semantic label, a pose, and a reconstructed grid. In this case, during the training, the image processing model may separately process an input object point cloud and an actual object grid by using an encoder. In this case, the encoder may receive the input object point cloud and the actual object grid. Alternatively, the image processing model may obtain a latent variable related to an input shape and a latent variable related to an actual shape by separately processing the input object point cloud and the actual object grid by using different encoders. In an inference stage, the image processing model may reconstruct a complete 3D grid of each object by using only a decoder.

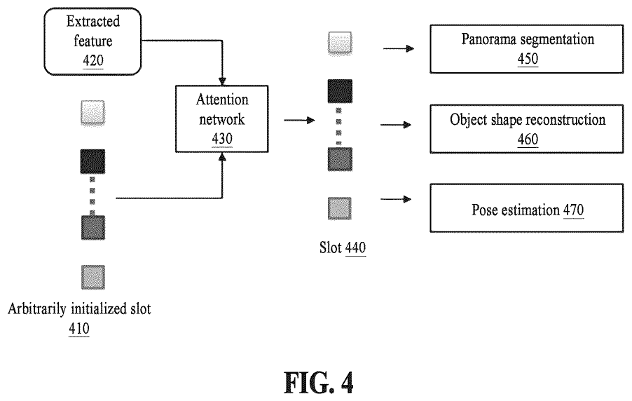

FIG. 4 is an example of a slot attention model according to one or more embodiments of the present disclosure.

Referring to FIG. 4, the slot attention model may extract a feature map from point cloud data and may input an arbitrarily initialized slot 410 and an extracted feature 420 to an attention network 430. As in the method described with reference to FIG. 3, each slot may compete for all features of one object or entity in a feature input through an attention mechanism based on softmax and each slot may be encoded correspondingly to one object or one entity in an input scene point cloud. Through N iterations, each slot may represent a corresponding object. In response to obtaining a slot of each object, the slot attention model may perform a panorama segmentation task 450, an object image reconstruction task 460, and a pose estimation task 470.

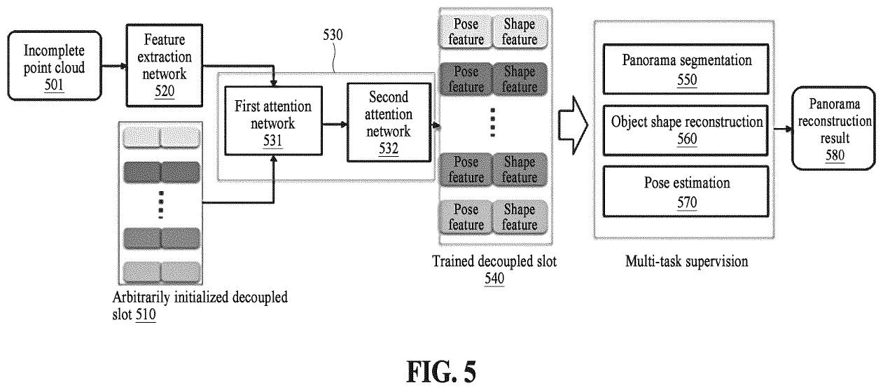

FIG. 5 is an example of a slot attention model according to one or more embodiments of the present disclosure.

To obtain more accurate pose estimation and shape reconstruction results, a feature of a first half of each slot may be referred to as a pose-related feature and a feature of a second half of each slot may be referred to as a shape-related feature. A slot attention network 530 of FIG. 5 may separate a shape feature space and a pose feature space in each slot. The slot attention network 530 of FIG. 5 may include two attention networks, wherein a first attention network 531 may process an arbitrary initialized decoupling slot 510 and a feature extracted from an incomplete point cloud 501 through a feature extraction network 520 and a decoupling slot 540 for each object may be obtained by applying a self-attention mechanism to an output of the first attention network 531 by using a second attention network 532. The decoupling slot 540 may retrieve more detailed information for shape reconstruction and more accurate pose estimation. In response to obtaining the decoupling slot 540 of each object, a panorama reconstruction result 580 may be obtained by performing a panorama segmentation task 550, an object image reconstruction task 560, and a pose estimation task 570.

The decoupling process shown in FIG. 5 is an example and a supervisory signal may be output from various tasks and a different supervisory task may be set depending on a different decoupling demand.

Since the decoupled slot is helpful in generating a more detailed reconstruction grid, the decoupled slot generated by the image processing method of one or more embodiments may be more suitable to panorama reconstruction of a scene compared to a typical slot.

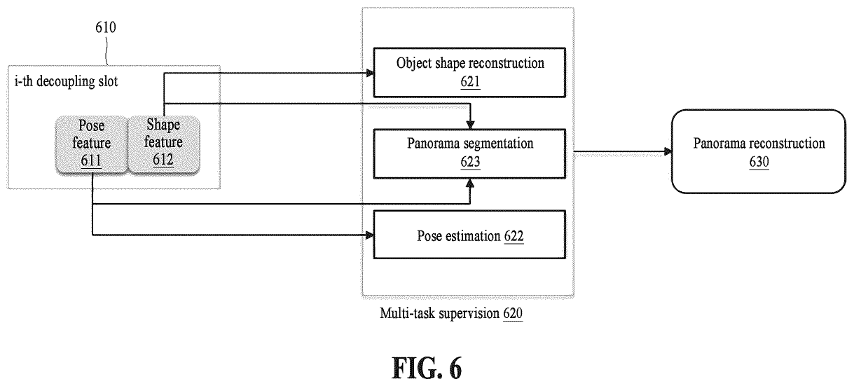

FIG. 6 is an example of panorama reconstruction using a decoupled slot according to one or more embodiments of the present disclosure.

Referring to FIG. 6, a detailed shape of a multi-task supervisory signal for feature decomposition is described using an i-th decoupling slot 610 as an example.

The image processing method may perform object shape reconstruction 621 by processing a first feature (e.g., a shape feature 612) related to a shape in the i-th decoupling slot 610 by using a first neural network, may perform object pose estimation 622 by processing a second feature (e.g., a pose feature 611) related to a pose in the decoupling slot by using a second neural network, may perform panorama segmentation 623 by processing the first feature related to the shape and the second feature related to the pose in the decoupling slot by using a third neural network, and then may perform panorama reconstruction 630 by using results of respective tasks.

The image processing method of one or more embodiments of the present disclosure may firstly use slot attention for point cloud processing, may perform scene panorama reconstruction in an integrated single-step network by combining with multi-task training, and through this, may significantly simplify a difficulty in training and manually adjusting a hyperparameter from a typical two-step method.

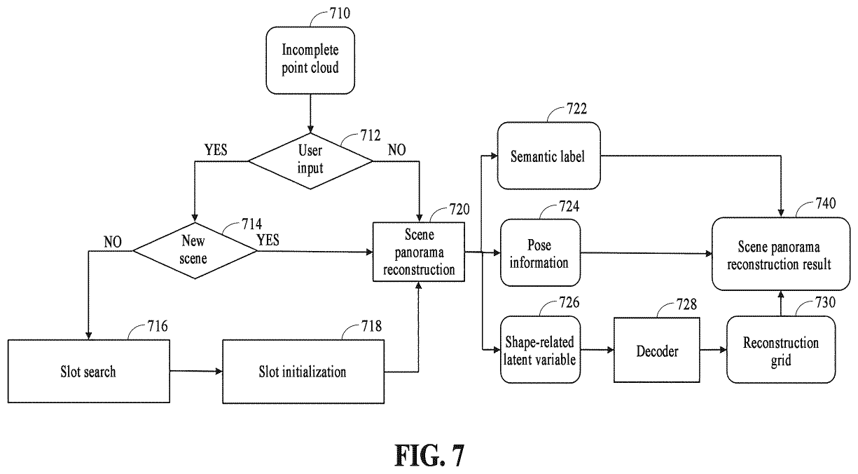

FIG. 7 is an example of applying an image processing model to an augmented reality (AR) device according to one or more embodiments of the present disclosure.

When an image processing method of the present disclosure receives an incomplete point cloud in operation 710, the image processing method may receive a response of a user related to whether a current scene is a new scene or an update for a previous scene in operation 712.

When the response of the user is received as a result of confirmation in operation 712, in operation 714, the image processing method of the present disclosure may confirm whether the current scene is a new scene based on the response of the user.

When the current scene is not a new scene and is an update for the previous scene as a result of confirmation in operation 712, the image processing method of the present disclosure may use a rapid slot search in operation 716, may perform slot initialization for a scene panorama reconstruction process in operation 718, and may perform scene panorama reconstruction in operation 720. Through this, the image processing method of one or more embodiments may need to perform only a small number of scans in a changed area to update the entire scene.

When the response of the user is not received as a result of confirmation in operation 712 or the current scene is a new scene as a result of confirmation in operation 714, the image processing method of the present disclosure may immediately perform scene panorama reconstruction 720.

In operation 720, the image processing method of the present disclosure may perform scene panorama reconstruction and may store a slot used for scene update and object tracking.

The image processing method of the present disclosure may generate a shape-related latent variable 726 obtained through scene panorama reconstruction as a reconstructed grid 730 through decoding by a decoder 728.

In addition, the image processing method of the present disclosure may obtain a scene panorama reconstruction result 740 by performing a task of directly combining a semantic label and mask 722, pose information 724, and the reconstructed grid 730.

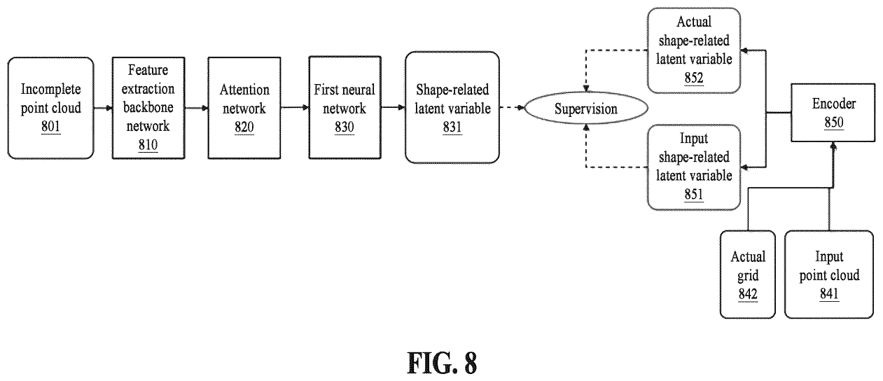

FIG. 8 is an example of first neural network training according to one or more embodiments of the present disclosure.

Referring to FIG. 8, to improve consistency between a reconstructed grid and an input point cloud, the image processing method of one or more embodiments of the present disclosure may input an input point cloud 841 to an encoder 850 corresponding to each instance or object when training a first neural network 830, may encode a shape-related latent variable (e.g., an input shape-related latent variable 851), and may encode an actual grid 842 of each instance or object as a shape-related latent variable (e.g., an actual shape-related latent variable 852) by inputting the actual grid 842 to the encoder 850 as a supervisory signal.

The image processing method of the present disclosure may input an incomplete point cloud 801 to a feature extraction backbone network 810 and may obtain a shape-related latent variable 831 through the feature extraction backbone network 810, an attention network 820, and the first neural network 830.

The image processing method of the present disclosure may determine a smoothed L1 loss by using the shape-related latent variable 831, the input shape-related latent variable 851, and the actual shape-related latent variable 852.

FIG. 8 shows a case in which the same neural network-based encoder 850 is used to encode the input point cloud 841 and the actual grid 842. The input point cloud 841 and the actual grid 842 may be individually encoded by using different neural network-based encoders.

The image processing method shown in FIG. 8 may determine whether an object shape estimated by the first neural network 830 coincides with the shape of the point cloud 841 and may generate the input shape-related latent variable 851 of the input point cloud 841 as a supervisory signal for the shape-related latent variable 831 output by the first neural network by using the encoder 850.

The compatibility may be significantly important to make the reconstructed object grid more consistent with the input point cloud when using a real-virtual interaction function in an AR application.

The method and system of one or more embodiments according to the present disclosure may be used for an AR system and when an image of a virtual object in a 3D space contacts an actual object, the actual object may be deformed according to the laws of physics in a screen of the AR system, and thereby, more realistic sense of immersion may be provided to the user.

The image processing model of one or more embodiments of the present disclosure has excellent scalability and more functions may be implemented by adding other auxiliary tasks other than the panorama segmentation task, the object shape reconstruction task, and the pose estimation task described above.

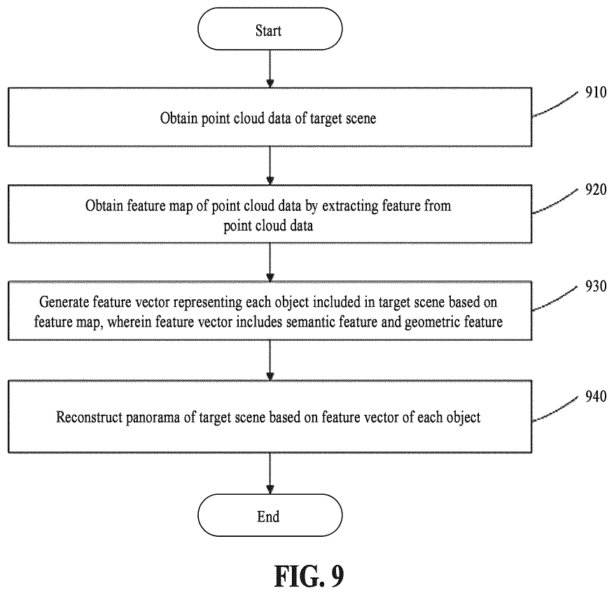

FIG. 9 is a flowchart of an image processing method according to one or more embodiments of the present disclosure.

Referring to FIG. 9, in operation 910, the image processing method of the present disclosure may obtain point cloud data of a target scene.

In operation 920, the image processing method of the present disclosure may obtain a feature map of the point cloud data by extracting a feature from the point cloud data. For example, the image processing method may obtain a multi-scale feature map of the point cloud data by extracting a feature from the point cloud data using sparse 3D U-NET and/or DGCNN.

In operation 930, the image processing method may generate a feature vector indicating each object included in the target scene based on the obtained feature map. In this case, the feature vector for representing an object may be a query vector based on disentanglement of semantic and geometric (e.g., an SGDQ vector) and for example, a feature vector of an object may be decoupled to a semantic feature portion related to semantics of the object and a geometric feature portion related to geometry of the object. The geometric feature may include, for example, a feature related to a shape of the object, a feature related to a mask of the object, and/or a feature related to a pose of the object and the example described above is an example and the present disclosure is not limited thereto.

For example, the image processing method may obtain an initial feature vector including an initial semantic feature related to semantics of the object and an initial geometric feature related to geometry of the object for each object and may obtain a feature vector of each object by processing the feature map and the initial feature vector of each object by using a neural network. In this case, the neural network used for obtaining an SGDQ vector of an object may be a transformer network. For example, the transformer network may be at least one sub-neural network and each sub-neural network may include at least a cross attention layer, a self-attention layer, and a feed forward neural network layer.

The transformer network may be a module for mapping from N input feature vector sets (e.g., an extracted multi-scale feature map) to K output feature vectors (e.g., an SGDQ vector). In an attention iteration of each SGDQ vector, each SGDQ vector may obtain all features of a specific portion (one object or one entity) of the input feature vector through the cross-attention and self-attention mechanisms. Each SGDQ vector may be respectively input to a subsequent multi-task MLP by encoding one object or one entity in a point cloud of the target scene.

For example, the feature vector of each object may be obtained by Equation 1 shown below, for example.

$$C = k ( M ( F ) ) \cdot {q ( S )}^{T} ∈ {ℛ}^{{N}_{f} \times K} , \\ {attn}_{i , j} = \frac{{c}^{{C}_{i , j}}}{{Σ}_{l} {e}^{{C}_{i , t}}} , \\ S = {W}^{T} \cdot v ( F ) ∈ {ℛ}^{K \times D} , where {W}_{i , j} = \frac{{attn}_{i , j}}{{Σ}_{I} {attn}_{l , j}} , \\ S = Self - attention ( S ) \\ S = FFN ( S ) . \qquad Equation 1$$

In this case, C may denote a correlation matrix of an attention mechanism, k may denote a key of the attention mechanism, M may denote a mask correlation operation, F may denote a multi-scale feature map, q may denote a query of the attention mechanism, S may denote an SGDQ vector, attn_{i,j} may denote an attention coefficient, W may denote a weight matrix, v may denote a value of k representing the attention mechanism, D may denote a dimension of the multi-scale feature map, S=W^{T}·υ(F)∈ [symbol] may denote an operation of a cross attention layer, S=Self-attention(S) may denote an operation of an attention layer, and S=FFN(S) may denote an operation of a feed forward neural network layer.

According to one or more embodiments of the present disclosure, a first half feature of each SGDQ vector may be a semantic feature and a second half of each SGDQ vector may be a geometric feature. The image processing method of the present disclosure may perform a category exclusive but individually independent task such as category prediction indicating an object semantic label by using the semantic feature of an SGDQ vector. Additionally, the image processing method of the present disclosure may perform a related task such as prediction of pose information by using the geometric feature combined with the semantic feature. The image processing method of the present disclosure may obtain an SGDQ vector as a supervisory signal for feature disentanglement. The SGDQ vector of one or more embodiments of the present disclosure may be more suitable to scene panorama reconstruction than a typical query vector.

One or more embodiments of the present disclosure may significantly simplify a difficulty in training and manually adjusting a hyperparameter from a typical two-step method by using SGDQ attention for point cloud processing and combining this with multi-task training for scene panorama reconstruction in an integrated single-step network.

In operation 940, the image processing method of the present disclosure may perform panorama reconstruction of the target scene based on a feature vector of each object.

For example, the image processing method of the present disclosure may obtain a semantic label, a mask, a shape-related latent variable, and pose information of each object by inputting a feature vector of each object to at least one neural network, respectively, and may perform panorama reconstruction of the target scene based on the semantic label, mask, shape-related latent variable, and the pose information of each obtained object. In this case, the semantic label may be obtained based on the semantic feature of the feature vector.

For example, the image processing method of the present disclosure may input a feature vector of each object to a multi-task MLP (e.g., the first to fourth MLPs). In this case, the first MLP may predict a semantic label of an object by using a semantic feature of a feature vector, the second MLP may predict a mask of the object using the semantic feature and a geometric feature of the feature vector, the third MLP may predict a shape-related latent variable of the object using the semantic feature and the geometric feature of the feature vector, and the fourth MLP may predict pose information of the object by using the semantic feature and the geometric feature of the feature vector. The example described above is only an example and the present disclosure does not limit the number and structure of MLPs.

According to another embodiment of the present disclosure, to obtain a more accurate estimation result, the image processing method may obtain subdivided pose information as final pose information based on the mask, pose information, and point cloud data of each obtained object, and/or may obtain a subdivided shape-related latent variable as a final shape-related latent variable based on the mask, shape-related latent variable, and point cloud data of each obtained object, and then may perform a panorama reconstruction task of the target scene based on the semantic label, mask, shape-related latent variable, and pose information of each obtained object.

For example, the image processing method of the present disclosure may obtain subdivided pose information based on the mask and pose information of the obtained each object and the point cloud data, and may perform panorama reconstruction of the target scene based on the semantic label, the mask, the subdivided shape-related latent variable related to the shape, and the subdivided pose information of each obtained object. The example described above is only an example and the image processing method of the present disclosure may simultaneously subdivide a plurality of prediction results or may individually subdivide one or a portion of predictions.

When subdividing the pose information, the image processing method of the present disclosure may obtain a feature related to a pose by processing a mask of each obtained object, the pose information, and the point cloud data, may obtain residual information related to a pose of each object based on the feature related to the pose and a feature vector of each object, and may obtain subdivided pose information based on the residual information related to the pose and the pose information of each object. For example, the image processing method of the present disclosure may obtain a pose-related feature (e.g., a pose detection feature) by processing the mask, the pose information, and the point cloud data (e.g., coordinate data of an object) of each object obtained by using one MLP. The pose-related feature may be stitched with the feature vector of each object and may predict residual information related to the pose of each object. For example, the image processing method of the present disclosure may predict residual information related to the pose based on the pose-related feature and the feature vector of each object by using a neural network or a different method. Finally, the image processing method of the present disclosure may take final pose information by combining predicted residual information with output pose information.

When segmenting a shape-related latent variable, the image processing method of the present disclosure may obtain a shape-related feature by processing a mask of each obtained object, a shape-related latent variable, and the point cloud data, may obtain residual information related to the shape of each object based on the shape-related feature and the feature vector of each object, and may obtain a subdivided shape-related latent variable based on the residual information related to the shape and the shape-related latent variable of each object. For example, the image processing method of the present disclosure may obtain a shape-related feature (e.g., a shape detection feature) by processing the mask of each obtained object, the shape-related latent variable, and the point cloud data (e.g., coordinate data of the object) by using one MLP. In this case, the image processing method of the present disclosure may predict shape-related residual information of each object by stitching the shape-related feature with the feature vector of each object. For example, the image processing method of the present disclosure may predict shape-related residual information based on the shape-related feature and the feature vector of each object by using a neural network or a different method. Finally, the image processing method of the present disclosure may generate a final shape-related latent variable by combining predicted residual information with the shape-related latent variable.

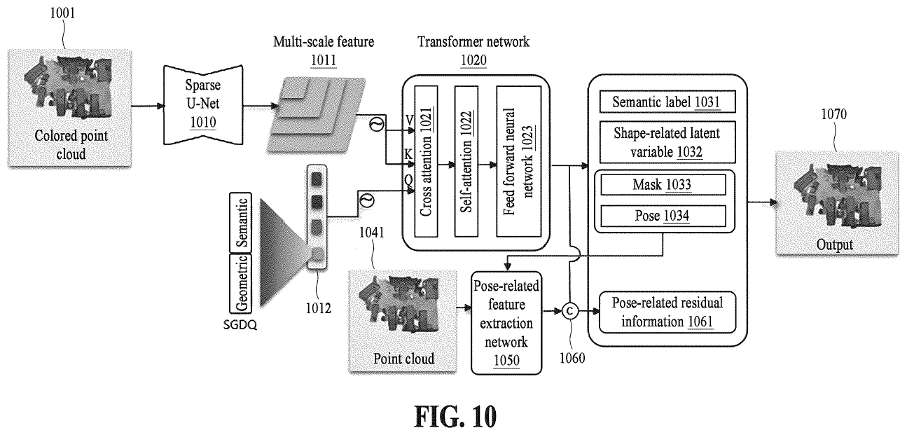

FIG. 10 is an example of a flow of an image processing method according to one or more embodiments of the present disclosure.

Referring to FIG. 10, in response to the image processing method of the present disclosure obtaining point cloud data 1001 (e.g., a colored point cloud), the image processing method may extract a feature from the point cloud data 1001 by using sparse U-NET 1010 and may obtain a multi-scale feature map 1011 of the point cloud data 1001. In this case, the obtained multi-scale feature map 1011 may be used as a Y vector and a K vector in the attention mechanism.

The image processing method of the present disclosure may obtain an initial feature vector for representing an object and an initial feature vector 1012 may include an initial semantic feature related to semantics of the object and an initial geometric feature related to the geometry of the object. The initial feature vector may be a randomly initialized vector (e.g., a Q-vector of the attention mechanism, for example, an SGDQ vector 1012) and may include both the semantic feature and the geometric feature.

The multi-scale feature map 1011 and the initial SGDQ vector 1012 may be input to a transformer network 1020. For example, the transformer network 1020 may be a multi-layer transformer decoder and each layer of the transformer decoder may include at least a cross attention layer 1021, a self-attention layer 1022, and a feed forward neural network layer 1023.

FIG. 10 shows one transformer decoder as an example but the present disclosure is not limited thereto. In an attention iteration of the SGDQ vector 1012, the SGDQ vector 1012 may obtain all features of a specific portion (one object or one entity) of an input feature vector through the cross attention and the self-attention mechanism. The SGDQ vector 1012 may encode one object or one entity only in the point cloud data and may input to a subsequent multi-task MLP, respectively. For example, the image processing method of the present disclosure may obtain a semantic label 1031 (e.g., a category), a mask 1033, a shape-related latent variable 1032, and pose information 1034 by inputting the SGDQ vector 1012 of each object to a plurality of MLPs (not shown), respectively.

For example, taking an i-th SGDQ vector as an example, similar to FIG. 6 (e.g., replacing a slot of FIG. 6 with SGDQ), the SGDQ vector 1012 may include a semantic feature portion and a geometric feature portion.

The image processing method of the present disclosure may perform object shape reconstruction by processing the semantic feature and the geometric feature of the SGDQ vector 1012, may perform object pose estimation by processing the semantic feature and the geometric feature of the SGDQ vector 1012, may perform object category prediction by processing a semantic feature of the SGDQ vector 1012, and may perform panorama reconstruction by using a result of each task in response to performing object mask estimation by processing the semantic feature and the geometric feature of the SGDQ vector 1012.

In response to obtaining the pose information 1034, the image processing method of the present disclosure may further subdivide the pose information 1034. For example, a pose-related feature may be obtained by processing the mask of each obtained object, the pose information, and the point cloud data (e.g., coordinate data of an object) by using a feature extraction network (e.g., one MLP) related to the pose. The pose-related feature may be stitched 1060 with the feature vector of each object and may predict pose-related residual information 1061 of each object. Finally, final pose information may be generated by combining the predicted pose-related residual information 1061 with the output pose information 1034.

FIG. 10 only shows subdividing the pose information, but the present disclosure may further subdivide a shape-related latent variable, a mask, and the like in a similar manner described above.

Finally, the image processing method of the present disclosure may perform panorama reconstruction of the target scene based on the semantic label 1031 of obtained each object, the mask 1033, the shape-related latent variable 1032, and the pose information 1034 and may output a result 1070 thereof.

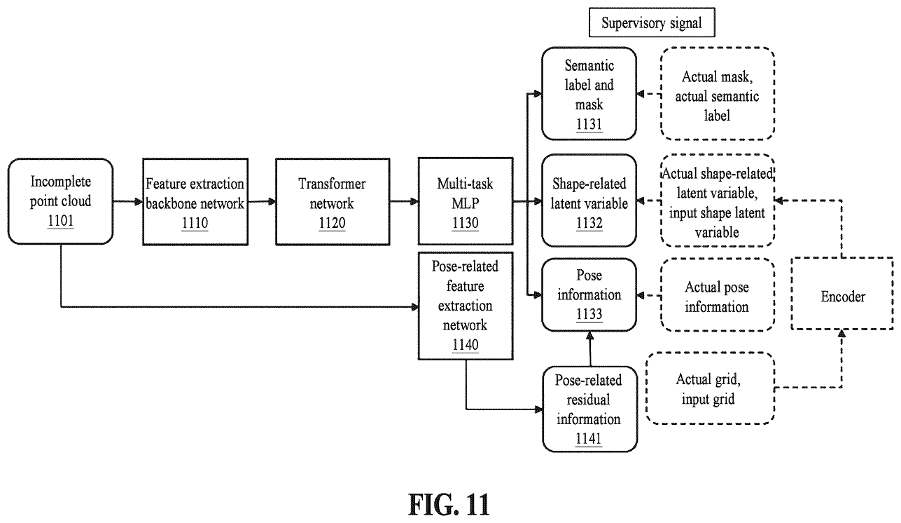

FIG. 11 is an architecture diagram of an image processing model according to one or more embodiments of the present disclosure.

The image processing model shown in FIG. 11 may include a configuration of a feature extraction backbone network 1110, a transformer network 1120, a multi-task MLP 1130, and a pose-related feature extraction network 1140.

Referring to FIG. 11, when the feature extraction backbone network 1110 receives point cloud data 1101, the feature extraction backbone network 1110 may extract a feature from the point cloud data 1101. In this case, the feature extraction backbone network 1110 may extract a feature from the point cloud data by using sparse 3D U-NET and/or DGCNN.

In this case, the point cloud data 1101 may be point cloud data of each object obtained by measuring a target scene using a 3D scanning device. Typically, the collected point cloud data 1101 may be incomplete point cloud data because an occlusion situation occurs when measuring an object in a scene.

The image processing model of the present disclosure may perform object-centric feature vector generation for a feature extracted by the feature extraction backbone network 1110 by using the transformer network 1120. For example, in an attention iteration of each SGDQ vector, each SGDQ vector may obtain all features of a specific portion (one object or one entity) of the input feature vector through the cross-attention and self-attention mechanisms. Each SGDQ vector may encode one object or one entity in a point cloud of the target scene and may input this to a subsequent multi-task MLP. Similarly, as shown in FIG. 3, in an indoor scene, an SGDQ vector representing each object (e.g., a table, a cabinet, and a stool) may be obtained by applying an attention competition mechanism for SGDQ to the feature map of the scene.

The image processing model of the present disclosure may input an SGDQ vector of each object to the multi-task MLP 1130, wherein the SGDQ vector is an object-centric feature vector generated through the transformer network 1120. For example, the multi-task MLP 1130 may include a plurality of MLPs, such as a first MLP for performing a panorama segmentation task, a second MLP for performing object shape reconstruction, and a third MLP for performing pose estimation. The first MLP may obtain a semantic label and mask 1131 for each object by processing an input SGDQ vector, the second MLP may obtain a shape-related latent variable 1132 (e.g., a shape-related latent variable and/or a latent distribution) for each object by processing the input SGDQ vector, and the third MLP may obtain estimated pose information 1133 for each object by processing the input SGDQ vector. The number and function of MLPs are examples and the present disclosure is not limited thereto.

When training the image processing model, a binary cross entropy loss may be used for a mask, a cross entropy loss may be used for a semantic label, a weighted L1 loss may be used for a shape-related latent variable, and a combination of a cross entropy loss and a weighted L1 loss may be used for a pose estimation result. For example, a binary cross entropy loss function may be configured by using an actual mask and a predicted mask, and a cross entropy loss function may be configured by using an actual semantic label and a predicted semantic label. The image processing model of the present disclosure may configure a weighted L1 loss function by using a latent variable related to an actual shape (e.g., obtained by processing an object point cloud input through a neural network-based encoder), a latent variable related to an input shape (e.g., obtained by processing an object point cloud input through a neural network-based encoder), and a latent variable related to a predicted shape, and may configure a hybrid loss function based on a cross entropy loss and a weighted L1 loss by using an actual pose and a predicted pose. The image processing model of the present disclosure may train or update a network parameter of the model by minimizing a result of the configured loss function. The loss is an example and the present disclosure is not limited thereto.

In addition, the image processing model of the present disclosure may obtain a pose-related feature by processing the pose information 1133, the mask, and the point cloud data 1101 using the pose-related feature extraction network 1140 (e.g., an MLP) to obtain a more accurate pose estimation result and may predict pose-related residual information 1141 of each object by combining the pose-related feature with the feature vector of each object. Lastly, the image processing model of the present disclosure may generate final pose information by combining predicted residual information with output pose information.

The image processing model shown in FIG. 11 may be an integrated single-step model to apply the model to an AR device by using SGDQ-based object-centric representation and technique to simultaneously perform object shape reconstruction and pose estimation. The semantic label and mask 1131 for segmentation of each object displayed as SGDQ, the pose information 1131 (e.g., a position and a direction), and the shape-related latent variable 1132, which is a latent variable representing the shape, may be simultaneously generated through a shape dictionary at an object category level that the network learned. The model of one or more embodiments may reduce complexity of hyperparameter adjustment and may prevent additional post-processing. Simultaneously, a result output by the image processing model may be used for an actual AR application.

The image processing model of the present disclosure may obtain the semantic label and mask 1131 of each object, the shape-related latent variable 1132, and the pose information 1133, may obtain an object grid by reconstructing the shape-related latent variable through decoding (e.g., shape decoding), and then may obtain panorama reconstruction of a final scene by performing a direct combination task on a panorama mask, a semantic label, a pose, and a reconstructed grid. In this case, during the training, the image processing model may separately process an input object point cloud and an actual object grid by using an encoder. In this case, the encoder may receive the input object point cloud and the actual object grid. Alternatively, an input shape-related latent variable and an actual shape-related latent variable may be obtained by respectively processing an input object point cloud and an actual object grid using different decoders. In an inference step, a complete 3D grid of each object may be reconstructed using only a decoder.

According to one or more embodiments of the present disclosure, as shown in FIG. 4, when a vector representing an object is an SGDQ vector, an extracted feature map and a randomly initialized SGDQ vector may be input to the transformer network 1120, each SGDQ vector may be encoded in correspondence to one object or one entity in an input scene point cloud, and N iterations may be performed such that each SGDQ vector is able to represent a corresponding object. In response to obtaining the SGDQ vector of each object, a panorama segmentation task, an object image reconstruction task, and a pose estimation task may be performed.

Training a neural network for SDGQ may be performed in the same manner as training a neural network for a slot. For example, referring to FIG. 8, when performing panorama reconstruction based on an SGDQ vector, the attention network 820 of FIG. 8 may be replaced with the transformer network 1120. When describing panorama reconstruction based on the SGDQ vector with reference to FIGS. 1 to 8, the description of the slot or the neural network of FIGS. 1 to 8 may be replaced with the description of the SGDQ or the neural network.

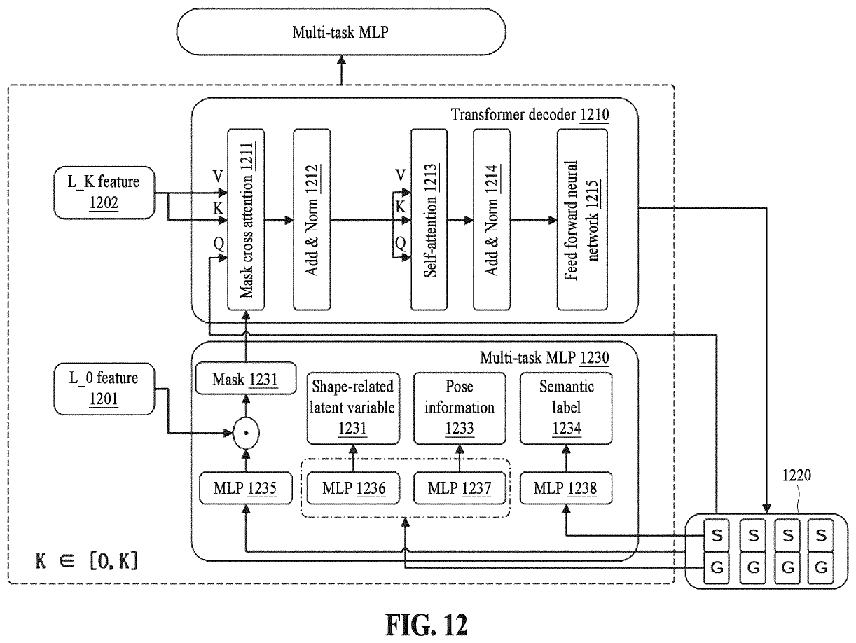

FIG. 12 is a flowchart of an image processing method according to one or more embodiments of the present disclosure.

Referring to FIG. 12, in response to an image processing method of the present disclosure extracting a multi-scale feature map (e.g., an L0 feature 1201, . . . , an Lk feature 1202, wherein k belongs to [0,K], and K is the number of layers of the multi-scale feature map) of point cloud data of a target scene, the image processing method may input a multi-scale feature and an initial SGDQ vector 1220 for representing each object of the target scene to a transformer network, and the transformer network may include a plurality of transformer decoders 1210. FIG. 12 only shows one transformer decoder 1210. In this case, the image processing method of the present disclosure may input the multi-scale feature and the SGDQ vector 1220 to a mask cross attention layer 1211, may perform addition and normalization 1212 on an output from the mask cross attention layer 1211, and may input a result thereof to a self-attention layer 1213. In addition, the image processing method of the present disclosure may perform addition and normalization 1214 on an output from the self-attention layer 1213 and may iteratively obtain an SGDQ vector 1220 of each object in the target scene through a feed forward neural network layer 1215 (in this case, S may denote a semantic feature and G may denote a geometric feature).

Then, the image processing method of the present disclosure may a mask 1231 of each object, a shape-related latent variable 1232, pose information 1233, and a semantic label (category) 1234 by passing the SGDQ vector 1220 of each object through a plurality of MLPs 1235, 1236, 1237, and 1238.

In this case, during a process of obtaining the mask 1231, the image processing method of the present disclosure may obtain the mask 1231 of the same dimension by performing point multiplication on a feature output by the corresponding MLP 1235 and one of multi-scale features (e.g., the L0 feature 1201). For example, the mask 1231 of the object may be obtained by Equation 2 shown below, for example.

$$M = σ ( L 0 {f}_{max = sk} ( S ) ) > 0.5 ∈ 0 , {1}^{N \times K} \qquad Equation 2$$

In this case, σ may denote a function, fₘₐₛₖ(S) may denote an output of an MLP corresponding to a mask, and N may denote the number of points of a point cloud.

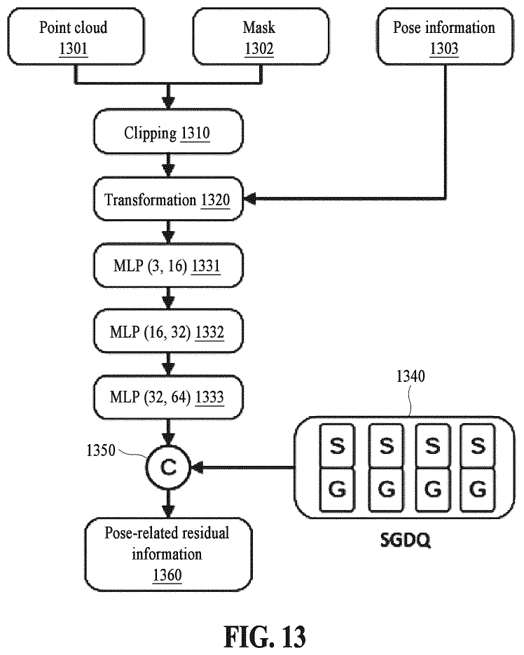

FIG. 13 is an example of subdivided pose information according to one or more embodiments of the present disclosure.

Referring to FIG. 13, in response to obtaining a mask 1302 of each object and pose information 1303, the image processing method of the present disclosure may crop (clip) an object from original point cloud data 1301 using the mask 1302, and then may convert an angle oC, which is pose information included in cropped point cloud data, by using the pose information 1303 (e.g., angle information) (e.g., applying a rotation angle to convert into a coordinate system for pose-related feature training).

A point indicating the object in the coordinate system may be input to multi-cascade MLPs 1331, 1332, and 1333 to extract a pose-related feature (e.g., a pose detection feature Foc). The extract pose detection feature may be combined 1350 with an SDGQ vector 1340 and may predict pose-related residual information 1360. In response to predicting the pose-related residual information 1360, the image processing method of the present disclosure may obtain subdivided pose information by combining the pose-related residual information 1360 with the pose information 1303.

FIG. 14 is an example of a structure of an image processing apparatus in a hardware operating environment according to one or more embodiments of the present disclosure.

In this case, an image processing apparatus 1400 may implement the panorama reproduction function. As shown in FIG. 14, the image processing apparatus 1400 may include a processor 1410 (e.g., one or more processors), a communication bus 1420, a network interface 1430, an input/output interface 1440, a memory 1450 (e.g., one or more memories), a power component 1460 (e.g., including one or more batteries), and a sensor 1470 (e.g., one or more sensors).

In this case, the communication bus 1420 may be used to implement a connection signal among the components. The input/output interface 1440 may include a video display (e.g., a liquid crystal display (LCD)), a microphone, a speaker, and a user interaction interface (e.g., a keyboard, a mouse, and a touch input device). Optionally, the input/output interface 1440 may further include a standard wired interface, and a wireless interface. The network interface 1430 may optionally include a standard wired interface and a wireless interface (e.g., a wireless fidelity interface). The memory 1450 may be high-speed random access memory and/or stable non-volatile memory. The memory 1450 may be an optional storage device independent of the processor 1410 described above. The sensor 1470 may be or include a 3D scanning apparatus and/or may be or include one or more high-resolution cameras, LiDAR (2D or 3D) sensors, RGB binoculars, 3D structure light cameras, and/or time-of-flight cameras.

The input/output interface 1440 may obtain point cloud data of a target scene. Alternatively or additionally, the sensor 1470 may collect the point cloud data of the target scene.

The processor 1410 may obtain a feature map of the point cloud data by extracting a feature from the point cloud data, may generate a feature vector representing each object included in the target scene based on the feature map, and may perform panorama reconstruction of the target scene based on the feature vector of each object. In this case, the feature vector of the object may be an SDGQ vector including a semantic feature and a geometric feature and/or a slot vector including a shape-related feature and a pose-related feature. However, the present disclosure is not limited thereto.

The neural network for implementing the present disclosure may perform panorama reconstruction as the neural network is trained by the image processing apparatus 1400 or is received from the outside.

Those skilled in the art may understand that the structure shown in FIG. 14 does not limit the image processing apparatus 1400, more or fewer components shown in the drawings may be included, or a combination of specific components or a different component arrangement may be included.

As shown in FIG. 14, the memory 1450 as a storage medium may include an operating system, such as a MAC operating system, a data storage module, a network communication module, a user interface module, and a program and a database related to the image processing method and the model training method.

In the image processing apparatus 1400 shown in FIG. 14, the network interface 1430 may be mainly used for data communication with an external device or terminal, and the input/output interface 1440 may be mainly used for data interaction with a user. The processor 1410 and the memory 1450 of the image processing apparatus 1400 may be set to the image processing apparatus 1400. The image processing apparatus 1400 may execute the image processing method and the model training method provided by the embodiments of the present disclosure by invoking various APIs provided by an operating system and a program stored in the memory 1450 for implementing the image processing method and the model training method of the present disclosure through the processor 1410.

The processor 1410 may include at least one processor and the memory 1450 may store a computer-executable instruction set. When the computer-executable instruction set is executed by at least one processor, the image processing method and the model training method according to one or more embodiments of the present disclosure may be executed. In addition, the processor 1410 may perform the image processing process or the model training process. However, the example is only an example and the present disclosure is not limited thereto. For example, the memory 1450 may include a non-transitory computer-readable storage medium storing instructions that, when executed by the processor 1410, configure the processor 1410 to perform any one, any combination, or all of the operations and/or methods disclosed herein with reference to FIGS. 1-13.

For example, the image processing apparatus 1400 may be an AR device, a personal computer (PC), a tablet device, a personal digital assistant (PDA), a smartphone, and/or other devices for executing the instruction set mentioned above. In this case, the image processing apparatus 1400 may not need to be a single electronic device and may be any device or assembly of circuits capable of individually or jointly executing the instruction (or the instruction set). The image processing apparatus 1400 may also be a part of an integrated control system or a system manager, or may be configured as a portable electronic device that locally or remotely (e.g., via wireless transmission) interfaces.

In the image processing apparatus 1400, the processor 1410 may include a central processing unit (CPU), a graphics processing unit (GPU), a programmable logic device, a dedicated processor system, a microcontroller, or a microprocessor. For example, the processor 1410 may further include an analog processor, a digital processor, a microprocessor, a multicore processor, a processor array, or a network processor, but the example is not limited thereto.

The processor 1410 may execute an instruction or code stored in the memory and the memory 1450 may further store data. The instruction and data may be transmitted or received through a network via the network interface 1430 capable of using an arbitrary known transmission protocol.

The memory 1450 may be integrated with a processor by arranging, for example, random-access memory (RAM) or flash memory in an integrated circuit microprocessor. In addition, the memory 1450 may include an independent device, such as an external disk drive, a storage array, or other storage devices that may be used by an arbitrary database system. The memory and the processor may be operatively integrated or may allow the processor to read a file stored in the memory by communicating with each other via an input/output (I/O) port or a network connection.

According to one or more embodiments of the present disclosure, an electronic device may be provided.

FIG. 15 is a block diagram of an electronic device according to one or more embodiments of the present disclosure.

Referring to FIG. 15, an electronic device 1500 of the present disclosure may include a memory 1510 (e.g., one or more memories), and a processor 1520 (e.g., one or more processors.

The at least one memory 1510 may store a computer-executable instruction set and when the computer-executable instruction set is executed by the at least one processor 1520, the image processing method and the model training method according to the embodiments of the present disclosure may be executed.

The processor 1520 may include a CPU, an audio and video processor, a programmable logic device, a dedicated processor system, a microcontroller, or a microprocessor. For example, the processor 1520 may also include an analog processor, a digital processor, a microprocessor, a multicore processor, a processor array, or a network processor, but the example is not limited thereto.

As a storage medium, the memory 1510 may include an operating system (e.g., a MAC operating system), a data storage module, a network communication module, a user interface module, a recommendation module, and a database.

The memory 1510 may be integrated with a processor 1520, and for example, RAM or flash memory may be arranged in an integrated circuit microprocessor. In addition, the memory 1510 may include a separate device, such as an external disk drive, a storage array, or other storage devices that may be used by a database system. The memory 1510 and the processor 1520 may be operatively integrated or may allow the processor 1520 to read a file stored in the memory 1510 by communicating with each other via an I/O port or a network connection.

In addition, the electronic device 1500 may further include a video display (e.g., an LCD) and a user interaction interface (e.g., a keyboard, a mouse, and a touch input device). All components of the electronic device 1500 may be connected to each other via a bus and/or a network.

For example, the electronic device 1500 may be an AR device, a PC, a tablet device, a personal digital assistant (PDA), a smartphone, and/or other devices for executing the instruction set. In this case, the electronic device 1500 may not need to be a single electronic device and may be a device or a set of circuits capable of individually or jointly executing the instruction (or the instruction set). The electronic device 1500 may also be a part of an integrated control system or a system manager, or may be configured as a portable electronic device that locally or remotely (e.g., via wireless transmission) interfaces.

Those skilled in the art may understand that the structure shown in FIG. 15 does not limit the electronic device 1500, more or fewer components shown in the drawings may be included, or a combination of specific components or a different component arrangement may be included.

At least one of configurations of the image processing apparatus 1400 or the electronic device 1500 may be implemented by an artificial intelligence (AI) model. AI-related functions may be performed by a non-volatile memory, a volatile memory, and a processor.

The processor may include at least one processor. In this case, the at least one processor may be a general-purpose processor (e.g., a CPU, an application processor (AP), etc.) or a graphics-dedicated processing unit (e.g., a GPU, a vision processing unit (VPU), and/or an AI-dedicated processor (e.g., a neural processing unit (NPU)).

The at least one processor may control processing of input data according to a predefined operation rule or an AI model stored in a non-volatile memory and a volatile memory. The predefined operation rules or AI model may be provided through training or learning. Here, providing the predefined operation rules or AI model through learning may indicate obtaining a predefined operation rule or AI model with desired characteristics by applying a learning algorithm to a plurality of pieces of training data. The training may be performed by a device having an AI function according to the disclosure, or by a separate server, device, and/or system.

The learning algorithm may be a method of training a predetermined target device, for example, a robot, based on a plurality of pieces of training data and of enabling, allowing or controlling the target device to perform determination or prediction. The learning algorithm may include, but is not limited to, for example, supervised learning, unsupervised learning, semi-supervised learning, or reinforcement learning.

The AI model may be obtained through training. In this case, “obtaining through training” may refer to training the AI model configured to execute a predefined operating rule or a required feature (or objective) by training a basic AI model with various pieces of training data through a training algorithm.

For example, the AI model may be include a plurality of neural network layers. Each layer may have a plurality of weights and the determination of one layer may be performed by a determination result of a previous layer and the plurality of weights of the current layer. A neural network may include, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), and a deep Q network, but is not limited thereto.

The electronic devices, memories, processors, sensors, image processing apparatuses, processing components, communication buses, network interfaces, input/output interfaces, power components, electronic device 1500, memory 1510, processor 1520, image processing apparatus 1400, processing component 1410, communication bus 1420, network interface 1430, input/output interface 1440, memory 1450, power component 1460, and sensor 1470 described herein, including descriptions with respect to respect to FIGS. 1-15, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-15 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method with image processing, the method comprising:
obtaining point cloud data of a target scene;
generating a feature map of the point cloud data by extracting a feature from the point cloud data;
for each of a plurality of objects included in the target scene, generating a feature vector indicating the object in the target scene based on the feature map; and
reconstructing a panorama of the target scene based on the feature vectors of the objects.

2. The method of claim 1, wherein, for each of the objects, the feature vector of the object comprises a semantic feature related to semantics of the object and a geometric feature related to geometry of the object.

3. The method of claim 1, wherein, for each of the objects, the generating of the feature vector of the object indicating the object included in the target scene based on the feature map comprises:
obtaining an initial feature vector of the object; and
obtaining the feature vector of the object by processing the feature map and the initial feature vector of the object by using a neural network,
wherein the initial feature vector comprises an initial semantic feature related to semantics of the object and an initial geometric feature related to geometry of the object.

4. The method of claim 3, wherein the neural network is a transformer network comprising one or more sub-neural networks comprising any one or any combination of any two or more of a cross attention layer, a self-attention layer, and a feed forward neural network layer.

5. The method of claim 1, wherein the reconstructing of the panorama of the target scene based on the feature vectors of the objects comprises, for each of the objects:
obtaining a semantic label of the object, a mask of the object, a shape-related latent variable of the object, and pose information of the object by inputting the feature vector of the object to one or more neural networks, respectively; and
reconstructing the panorama of the target scene based on the semantic label of the object, the shape-related latent variable of the object, and the pose information of the object,
wherein the semantic label of the object is obtained based on the semantic feature of the feature vector.

6. The method of claim 5, wherein the reconstructing of the panorama of the target scene comprises:
obtaining subdivided pose information of the object as pose information of the object based on the mask of the object, the pose information of the object, and the pose cloud data;
obtaining a subdivided shape-related latent variable of the object as a shape-related latent variable of the object based on the mask of the object, the shape-related latent variable of the object, and the point cloud data; and
reconstructing the panorama of the target scene based on the semantic label of the object, the mask of the object, and the shape-related latent variable of the object, and the pose information of the object.

7. The method of claim 6, wherein the obtaining of the subdivided pose information of the object comprises:
obtaining a pose-related feature of the object by processing the mask of the object, the pose information of the object, and the point cloud data;
obtaining pose-related residual information of the object based on the pose-related feature of the object and the feature vector of the object; and
obtaining subdivided pose information of the object based on the pose-related residual information of the object and the pose information of the object.

8. The method of claim 6, wherein the obtaining of the subdivided shape-related latent variable comprises:
obtaining the shape-related feature of the object by processing the mask of the object, the shape-related latent variable of the object, and the point cloud data;
obtaining shape-related residual information of the object based on the shape-related feature of the object and the feature vector of the object; and
obtaining the subdivided shape-related latent variable of the object based on the shape-related residual information of the object and the shape-related latent variable of the object.

9. The method of claim 1, further comprising:
determining whether the target scene is a new scene;
in response to determining that the target scene a new scene, storing the feature vector of the object; and
in response to determining that the target scene is a scene associated with a previous scene, obtaining an initial feature vector of an object corresponding to the target scene by initializing a feature vector of the object corresponding to the target scene by using a feature vector of an object included in the previous scene.

10. The method of claim 9, wherein the determining of whether the target scene is a new scene comprises:
outputting information that asks whether the target scene is a new scene;
in response to feedback information being received, determining whether the target scene is a new scene based on the feedback information; and
in response to the feedback information not being received, determining the target scene to be the new scene.

11. The method of claim 5, wherein the reconstructing of the panorama of the target scene comprises:
obtaining an object grid of the object by decoding the latent variable using a decoder; and
obtaining a panoramic view of the target scene by combining the semantic label of the object, the mask of the object, the object grid of the object, and the pose information of the object.

12. A non-transitory computer-readable storage medium storing instructions that, when executed by one or more processors, configure the one or more processors to perform the method of claim 1.

13. An electronic device comprising:
one or more processors configured to:
obtain point cloud data of a target scene;
generate a feature map of the point cloud data by extracting a feature from the point cloud data;
for each of a plurality of objects included in the target scene, generate a feature vector indicating the object in the target scene based on the feature map; and
reconstruct a panorama of the target scene based on the feature vectors of the objects.

14. The electronic device of claim 13, wherein, for the generating of the feature vector of the object for each of the objects, the one or more processors are further configured to:
obtain an initial feature vector of the object; and
obtain the feature vector of the object by processing the feature map and the initial feature vector of the object by using a neural network,
wherein the initial feature vector comprises an initial semantic feature related to semantics of the object and an initial geometric feature related to geometry of the object.

15. The electronic device of claim 13, wherein, for the reconstructing of the panorama of the target scene, the one or more processors are further configured to, for each of the objects:
obtain a semantic label of the object, a mask of the object, a shape-related latent variable of the object, and pose information of the object by inputting the feature vector of the object to one or more neural networks, respectively; and
reconstruct the panorama of the target scene based on the semantic label of the object, the shape-related latent variable of the object, and the pose information of the object.

16. The electronic device of claim 15, wherein, for the reconstructing of the panorama of the target scene, the one or more processors are further configured to:
obtain subdivided pose information of the object as pose information of the object based on the mask of the object, the pose information of the object, and the pose cloud data;
obtain a subdivided shape-related latent variable of the object as a shape-related latent variable of the object based on the mask of the object, the shape-related latent variable of the object, and the point cloud data; and
reconstruct the panorama of the target scene based on the semantic label of the object, the mask of the object, and the shape-related latent variable of the object, and the pose information of the object.

17. The electronic device of claim 16, wherein, for the obtaining of the subdivided pose information, the one or more processors are further configured to:
obtain a pose-related feature of the object by processing the mask of the object, the pose information of the object, and the point cloud data;
obtain pose-related residual information of the object based on the pose-related feature of the object and the feature vector of the object; and
obtain subdivided pose information of the object based on the pose-related residual information of the object and the pose information of the object.

18. The electronic device of claim 16, wherein, for the obtaining of the subdivided shape-related latent variable, the one or more processors are further configured to:
obtain the shape-related feature of the object by processing the mask of the object, the shape-related latent variable of the object, and the point cloud data;
obtain shape-related residual information of the object based on the shape-related feature of the object and the feature vector of the object; and
obtain the subdivided shape-related latent variable of the object based on the shape-related residual information of the object and the shape-related latent variable of the object.

19. The electronic device of claim 13, wherein the one or more processors are further configured to:
determine whether the target scene is a new scene;
in response to determining that the target scene is a new scene, store the feature vector of the object; and
in response to determining that the target scene is a scene associated with a previous scene, obtain an initial feature vector of an object corresponding to the target scene by initializing a feature vector of the object corresponding to the target scene by using a feature vector of an object included in the previous scene.

20. The electronic device of claim 15, wherein, for the reconstructing of the panorama of the target scene, the one or more processors are further configured to:
obtain an object grid of the object by decoding the latent variable using a decoder; and
obtain a panoramic view of the target scene by combining the semantic label of the object, the mask of the object, the object grid of the object, and the pose information of the object.
